(19) United States
(12) Patent Application Publication
(10) Pub. No.: US 2009/0172155 A1
(43) Pub. Date: Jul. 2, 2009

(54) METHOD AND SYSTEM FOR MONITORING, COMMUNICATING, AND HANDLING A DEGRADED ENTERPRISE INFORMATION SYSTEM

(75) Inventors: Michael Richard ARTOBELLO, Concord, CA (US); David Andrew Cameron, Nobleton (CA); Elvis Bruce Halcrombe, San Jose, CA (US); Jack Chiu-Chiu Yuan, San Jose, CA (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 11/968,392

(22) Filed: Jan. 2, 2008

(51) Int. Cl. G06F 15/173

(52) U.S. Cl. 709/224

(57) ABSTRACT

A system and method in accordance with the present invention provides a 3-phase commit client-server protocol that allows the EIS server to detect the sick-but-not-dead situations, identify the resources involved, determine its degraded level, take the actions if needed, and send out a degraded status information message to the client. In a system and method in accordance with the present invention an internal availability monitor analyzes the resources that have not been externalized, such as storage pools, control blocks, etc, and are therefore not available to external monitors.

### FIELD OF THE INVENTION

The present invention relates generally to a service oriented architecture and more particularly relates to a method and system for monitoring such an architecture.

### BACKGROUND OF THE INVENTION

In today's service-oriented architecture (SOA) environment, when an enterprise information system (EIS) such as information management system (IMS), becomes degraded (i.e. sick but not dead) and is unable to effectively process the work submitted by a web service, the web service is usually unaware of the situation and continues sending work to the EIS. This often compounds the situation with flooded transactions and the result is an EIS outage and disrupted web service.

The EIS could respond by rejecting all incoming work from the web service. However, this is a shotgun approach and it may not even be possible. The EIS may still be able to process some work depending on the severity of the problem and/or the resources involved. And this ‘sick but not dead’ issue in the EIS could be a temporary condition.

A solution is needed for customers to be able to determine if the EIS is degraded for work, and if the EIS is degraded, the work needs to be rerouted to another EIS, if available. FIG. 1 is a diagram which shows a complex SOA network 10 with a potential degraded enterprise information system (EIS), such as IMS. This is especially vital for high transaction volume systems where response times are critical. Any delay in processing this information could have an adverse effect on a company's business. There are vendor products which provide the external health monitors in order to send alerts to automation software, which perform operator actions and normally use external interfaces, such as operator commands and API's. However these systems do not allow for the determination of internal problems within the SOA architecture.

Thus, what is desired is a method and system for monitoring an EIS for a degraded condition that is more effective than conventional solutions. The method and system should be easy to implement cost effective and adaptable to existing environments. The present invention addresses such a need.

### SUMMARY OF THE INVENTION

A system and method in accordance with the present invention provides a 3-phase commit client-server protocol that allows the EIS server to detect the sick-but-not-dead situations, identify the resources involved, determine its degraded level, take the actions if needed, and send out a degraded status information message to the client. In a system and method in accordance with the present invention an internal availability monitor analyzes the resources that have not been externalized, such as storage pools, control blocks, etc, and are therefore not available to external monitors.

### BRIEF DESCRIPTION OF DRAWINGS

FIG. 1 is a diagram which shows a complex service oriented architecture (SOA) network.

FIG. 2 illustrates the SOA network of FIG. 1 in accordance with the present invention.

FIG. 3 is a flow chart of a three phase commit protocol in accordance with the present invention.

FIG. 4 shows the format of an availability message with overall status code and bit maps in accordance with the present invention.

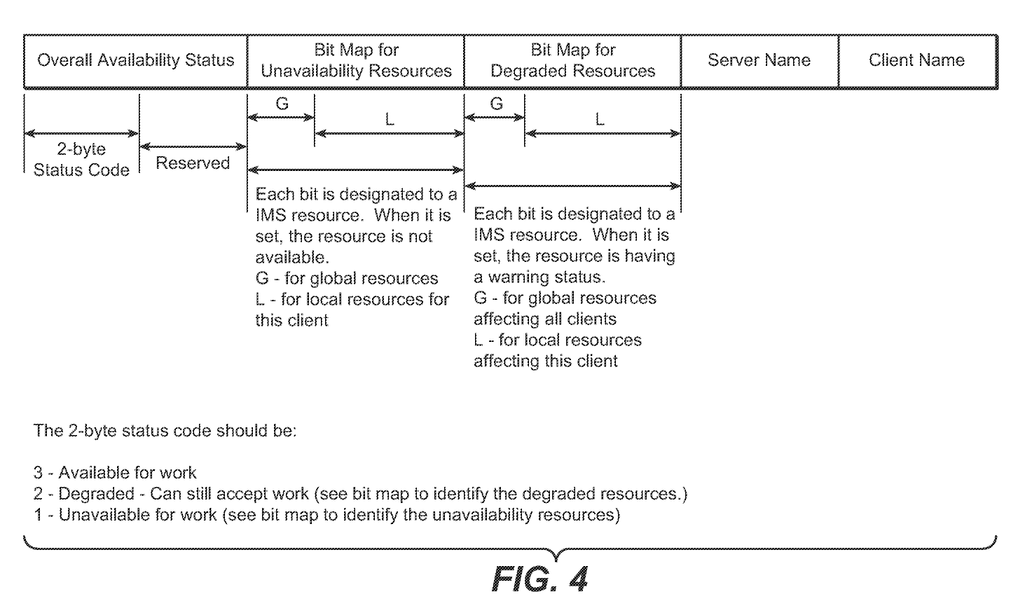

### DETAILED DESCRIPTION OF PREFERRED EMBODIMENTS

The present invention relates generally to a service oriented architecture and more particularly relates to a method and system for monitoring such an architecture. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

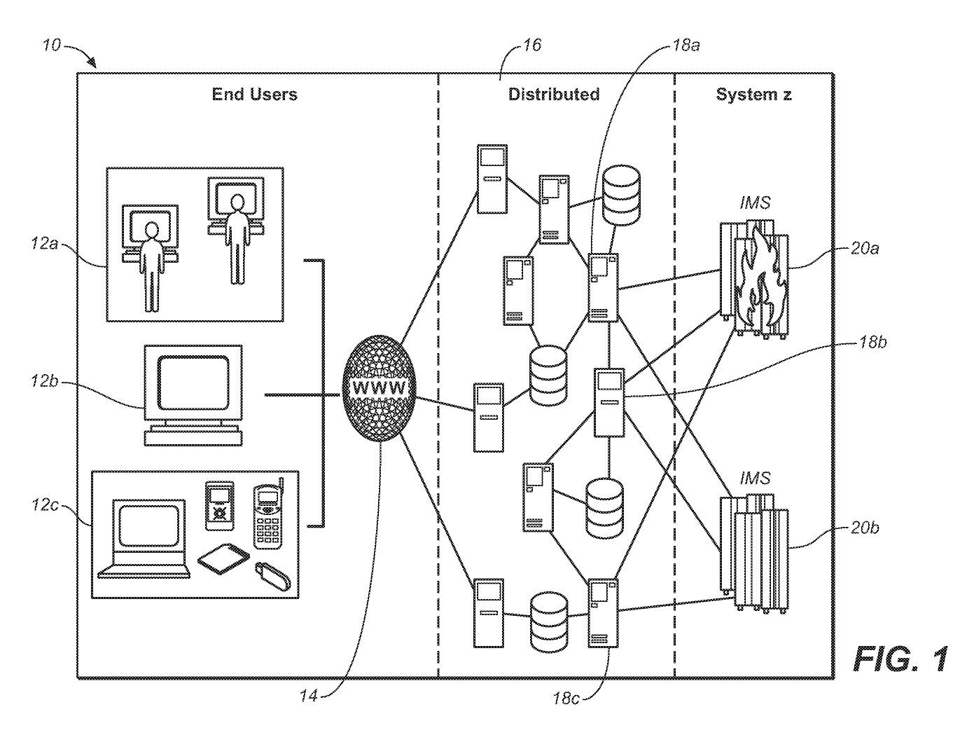

FIG. 1 is a diagram which shows a complex SOA network 10. The SOA network 10 includes a plurality end users 12a-12c which are in communication with a public network 14 such as the world wide web. The public network in turn is coupled to a distributed network 16 of clients 18a-18c. The distributed network 16 in turn is coupled to one or more EIS servers 20a and 20b. In this embodiment EIS 20a is potentially degraded. This degradation can cause significant problems in many environments. To minimize the degradation issue is especially vital for high transaction volume systems where response times are critical. Any delay in processing this information could have an adverse effect on a company's business.

A system and method in accordance with the present invention provides a 3-phase commit client-server protocol that allows the EIS server 20a to detect the sick-but-not-dead situations, identify the resources involved, determine its degraded level take the actions if needed, and send out a degraded status information message to the client 18.

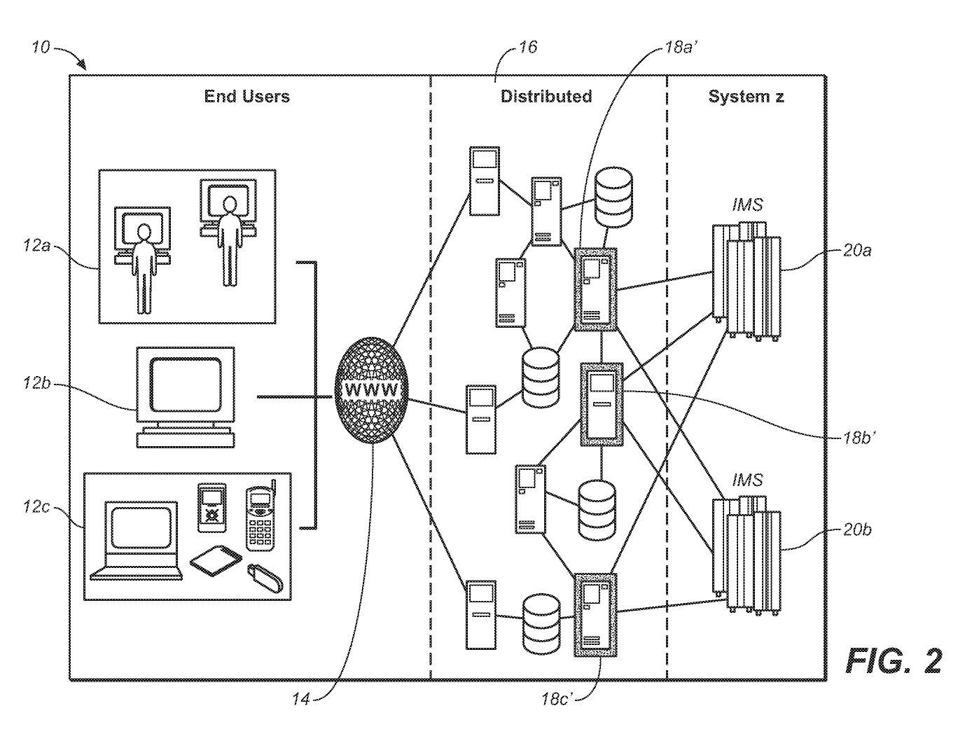

FIG. 2 illustrates the SOA network of FIG. 1. In this embodiment, three clients 18a′, 18b′ and 18c are utilized as an immediate gateway to the EIS server 20a. The status information would then be processed by the immediate gateway of the EIS server 20a where additional action can be taken (e.g., continue to send work to a degraded EIS server 20a or reroute work for another EIS server 20b).

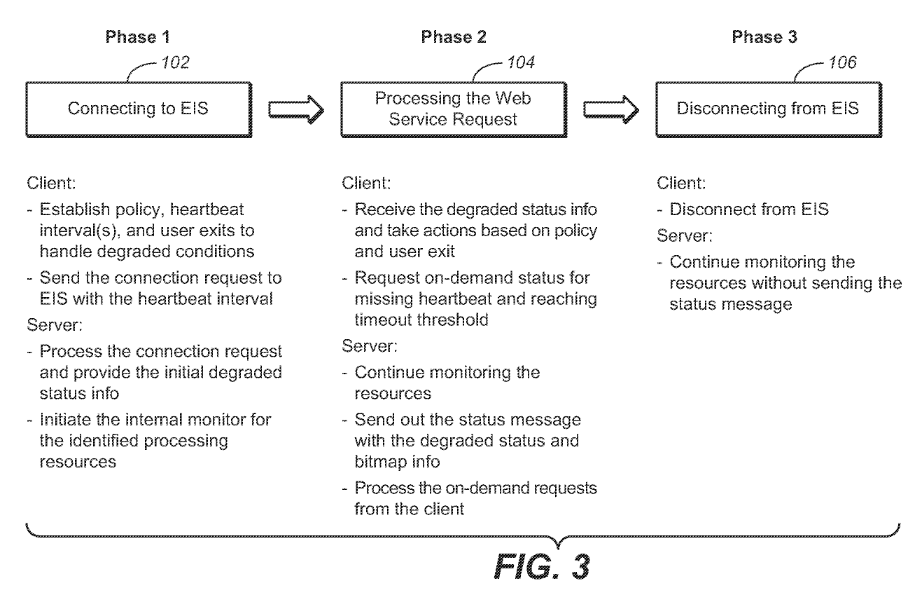

FIG. 3 is a flow chart of a three phase commit protocol in accordance with the present invention. A first phase is connecting to the EIS server 20a by a client 18, via step 102. The second phase is processing a web service request via step 104 and the third phase is disconnecting from the EIS server 20a. The function of each of these phases will be described in more detail hereinbelow.

### Phase 1—Connecting to the EIS Server 102

Before a client 18 connects to the EIS server 20a, the client 18 establishes a configuration file to set policy thresholds and a heartbeat interval. The heartbeat interval identifies how often the EIS server 20a needs to send availability information with any degraded status to the client 18. Policies can deal with different degraded situations of the EIS server 20a (e.g. server not available, server degraded, etc.).

The client 18 could set two heartbeat intervals, a primary interval, used when the EIS server 20a is healthy, and a secondary interval used when the EIS server 20a is degraded.

After the client 18 submits the connection request with the specified heartbeat interval(s) to an EIS server 20a, the EIS server 20a initiates an internal monitor to examine the processing resources needed for the client 18 and responds to the connection request with the initial server 20a degraded status information. The client 18 can terminate the connection if the initial status is negative. Please find below the respective activities of the client 18 and the EIS server 20 during phase 1.

Client: The client 18 establishes policy, heartbeat interval(s) and user exits to handle degraded conditions. The client 18 then sends the connection request to the EIS server 20 with the heartbeat interval.

EIS Server: The EIS server 20 processes the connection request and provides the initial degraded status information. The EIS server 20 also initiates an internal monitor for the identified processing resources.

Phase 2—Processing the Requests from Web Service 104

In this phase, while the EIS server 20a is busy processing the transaction requests from Web services, the internal monitor in the EIS server 20a for the ‘sick-but-not-dead’ conditions will continue monitoring the processing resources, such as the storage pool threshold, the longest elapse time of the un-processed transaction requests, the number of total un-completed transaction control blocks for this client 18, the message flood level, the longest queue depth of an un-processed input transactions, the number of expired transaction requests, and the queue depth of un-delivered transaction output.

Some of the resources will have a global availability status and a client availability status. The global availability status will be used to report on global resources, such as storage. The client availability status will be used to report on client 18 specific resources.

To simplify the protocol processing, the EIS server 20 will maintain an availability level which represents its ability to process work. The following levels can be used.

3—Available for work.

2—Degraded—Can still accept work.

1—Unavailable for work.

This availability level information will be sent to the client 18 at the specific intervals requested by the client 18. In addition to the availability status, the EIS server 20 will provide a bit map which identifies each processing resource classification which could trigger the change in availability. This bit map can be used for the detailed problem determination for the cause of the sick-but-not-dead condition.

Normally the availability status will be updated at the next heartbeat. However, if the EIS server 20a detects a severe problem, it would immediately update its availability status and send that information to the client 18. When the condition has been alleviated, the client 18 will be informed too.

The client 18 could also request server availability on demand if it detects a potential problem, such as timeouts. The client 18 can also monitor the heartbeat interval and if the EIS server 20a fails to respond within the specified timeframe the client 18 can either request an immediate status from the EIS server 20a or take appropriate action, such as rerouting work to another EIS server 20b.

The server availability status can be passed to a user exit at the client side to take the appropriate action based on the defined policies. The user exit can be written by the customer to take action when thresholds are reached (e.g. continue send work to the EIS server 20a or reroute work to another server 20b). This can be an existing user exit or a new user exit created specifically for this purpose. A sample user exit, with default actions, can also be supplied. The exit can be called whenever there's a change in the server availability status or can be called whenever a new transaction arrives.

If the client 18 has not requested availability status at connect time, when the EIS server 20a detects a potential problem, it may act upon its own to restrict the transaction flow from the client 18, such as rejecting all incoming work from the client 18.

### Availability Message

FIG. 3 shows the format of an availability message with overall status code and bit maps.

Overall ability status includes a 2-byte status code and reserved area. The 2-byte status code is, for example:

3—available for work.

2—degraded—can still accept work (see bit map to identify the degraded resources).

1—Unavailable for work (see bit map to identity the unavailability resources).

In a bit map for unavailability resources, each bit is designated to a EIS server. When the bit is set, the resource is not available. The area marked as G is for global resource server and the area marked as L is for local resources for the client.

In a bit map for the degraded resources, each bit is designated to a EIS server resource. When the bit is set, the resource has a warning status, the area marked for G for is for global resources affecting all clients and the area marked as L is for local resources affecting this client.

Please find below the respective activities of the client 18 and the EIS server 20a during phase 2.

Client: The client 18 receives the degraded status info and take actions based on policy user and user exit. The client 18 requests on-demand status for missing heartbeat and reaching timeout threshold.

EIS Server: The EIS server 20 continues monitoring the resources. The EIS server 20 sends out the status message with the degraded status and bitmap information. The EIS server 20 also processes the on-demand requests from the client.

Phase 3—Disconnecting from EIS server 106

After the client 18a then disconnects from the EIS server 20a, the EIS server 20a will continue monitoring the processing resources, but not send out the availability status with the degraded info. This is needed so that all of the information can be ready once the client 18a is reconnected.

This information message would then be processed by the immediate gateway of EIS (i.e. client 18a, 18b and 18c) where additional action can be taken (e.g. continue to send work to the EIS server 20a or reroute work to another EIS server 20b.)

Communication between the client 18 and EIS server 20 will be at the protocol level for efficiency purposes. This communication will not be affected even when the EIS server 20a is in a degraded state.

Please find below the activities of the client 18 and the EIS server 20 during phase 3. Client. The client 18 disconnects from EIS Server 20. EIS server. The EIS server 20 continues monitoring the resources without sending the status message.

In a system and method in accordance with the present invention an internal availability monitor analyzes the resources that have not been externalized 3 such as storage pools, control blocks, etc, and are therefore riot available to external monitors.

Using this three phase commit client-server protocol, the EIS server 20a can then send alerts directly to a client 18. The client 18 can then decide what action to take based on the availability level, using a rules based user exit. These are functions that are generally not available to operators or automation software, which normally deal on a server-wide level and riot on a client level.

The other aspect of a system and method in accordance with the present invention is that the EIS server 20a is allowed to protect itself and possibly self-correct to avoid a EIS server 20a outage, in addition to notifying the client 18. The client 18 also has the ability to inform the Web service which is also something not generally supported by external monitors.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for monitoring an enterprise information system (EIS) server by a client comprising:
connecting to the EIS server in a first phase; wherein in the first phase, the client establishes a policy, heartbeat intervals and user exits to handle degraded conditions of the EIS server, the client sends a connection request to the EIS server with a heartbeat interval the EIS server processes the connection request and provides initial degraded status information, the EIS server initiates an internal monitor for identified processing resources;
processing requests from a web service in a second phase; wherein in the second phase, the client receives the degraded status information and takes action based on the policy and user exits and requests status for missing heartbeat intervals and reaching timeout threshold; the EIS server monitors identified processing services; sends an availability message with degraded status information to the client and processes the status requests from the client; and
disconnecting the client from the EIS server in a third phase, wherein in the third phase the EIS server monitors the processing resources without sending a status message.

2. The method of claim 1 wherein the heartbeat interval identifies how often the EIS server needs to send availability information with a degraded status to the client.

3. The method of claim 1 wherein the heartbeat interval comprises a plurality of heartbeat intervals, the plurality of heartbeat levels includes a primary interval when the EIS server is healthy and a secondary interval when the EIS server is degraded.

4. The method of claim 1 wherein the EIS server maintains an availability level which represents the ability of the EIS server to process work.

5. The method of claim 4 wherein the availability levels comprise first, second and third levels, wherein the first level indicates that the EIS server is unavailable for work, the second level indicates that the EIS server is degraded but can still accept work and the third level indicates that the EIS server is available for work.

6. The method of claim 1 wherein the availability message includes an overall availability status, a bit map for unavailability resources, a bit map for degraded resources, and the EIS server name to identify the source of the message.

7. The method of claim 1 wherein the overall ability status comprises a 2-byte status code.

8. A system for monitoring an enterprise information system (EIS) server by a client comprising:
means for connecting to the EIS server in a first phase; wherein in the first phase, the client establishes a policy, heartbeat intervals and user exits to handle degraded conditions of the EIS server, the client sends a connection request to the EIS server with a heartbeat interval, the EIS server processes the connection request and provides initial degraded status information, the EIS server initiates an internal monitor for identified processing resources;
means for processing requests from a web service in a second phase; wherein in the second phase the client receives the degraded status information and takes action based on the policy and user exits and requests status for missing heartbeat intervals and reaching timeout threshold; the EIS server monitors identified processing services; sends an availability message with degraded status information to the client and processes the status requests from the client; and
means for disconnecting the client from the EIS server in a third phase, wherein in the third phase the EIS server monitors the processing resources without sending a status message.

9. The system of claim 1 wherein the heartbeat interval identifies how often the EIS server needs to send availability information with a degraded status to the client.

10. The system of claim 1 wherein the heartbeat interval comprises a plurality of heartbeat intervals, the plurality of heartbeat levels includes a primary interval when the EIS server is healthy and a secondary interval when the EIS server is degraded.

11. The system of claim 1 wherein the EIS server maintains an availability level which represents the ability of the EIS server to process work.

12. The system of claim 4 wherein the availability levels comprise first second and third levels, wherein the first level indicates that the EIS server is unavailable for work, the second level indicates that the EIS server is degraded but can still accept work and the third level indicates that the EIS server is available for work.

13. The system of claim 1 wherein the availability message includes an overall availability status, a bit map for unavailability resources, a bit map for degraded resources and the EIS server name to identify the source of the message.

14. The system of claim 1 wherein the overall ability status comprises a 2-byte status code.

15. A method for monitoring an enterprise information system (EIS) server by a client comprising:
connecting to the EIS server in a first phase; wherein in the first phase, the client establishes a policy, heartbeat intervals and user exits to handle degraded conditions of the EIS server the client sends a connection request to the EIS server with a heartbeat interval wherein the heartbeat interval identifies how often the EIS server needs to send availability information with a degraded status to the client, the EIS server processes the connection request and provides initial degraded status information, the EIS server initiates an internal monitor for identified processing resources;
processing requests from a web service in a second phase; wherein in the second phase, the client receives the degraded status information and takes action based on the policy and user exits and requests status for missing heartbeat intervals and reaching timeout threshold; the EIS server monitors identified processing services; sends an availability message with degraded status information to the client and processes the status requests from the client; wherein the availability level wherein the EIS server maintains an availability level which represents the ability of the processor to process work, comprise first, second and third levels, wherein the first level indicates that the EIS server is unavailable for work, the second level indicates that the EIS server is degraded but can still accept work and the third level indicates that the EIS server is available for work, wherein the availability message includes an overall availability status, a bit map for unavailability resources and a bit map for degraded resources; and
disconnecting the client from the EIS server in a third phase, wherein in the third phase the EIS server monitors the processing resources without sending a status message.
